(19) United States
(12) Patent Application Publication
(10) Pub. No.: US 2002/0143632 A1
(43) Pub. Date: Oct. 3, 2002

(54) Internet-based system of obtaining data from consumers in order to provide them access to promotions matching their profiles, and doing so without collecting either their identity or contact information

(76) Inventors: Douglas Walter, Cumming, GA (US); Christian Nehammer, Estero, FL (US)

Correspondence Address: DOUG WALTER, 6725 Chelsea Gardens Way, Cumming, GA, 30040, US

(21) Appl. No.: 10/095,646

(22) Filed: Mar. 12, 2002

(51) Int. Cl. G06F 17/60

(52) U.S. Cl. 705/14

(57) ABSTRACT

A method is provided for conducting targeted database marketing over a computer network (such as the Internet) whereby the consumer does not provide identity or contact information and remains anonymous to all parties, including the database marketer. The invention belongs to the category of Internet related marketing methods with several remote computers involved.

### CROSS REFERENCE TO

U.S. patent application 2001/0013011 A1

U.S. patent application 2002/0003162 A1

U.S. patent application Ser. No. 5,724,521

U.S. patent application Ser. No. 5,974,398

U.S. patent application Ser. No. 6,026,369

U.S. patent application Ser. No. 6,055,510

U.S. patent application Ser. No. 6,182,050 B1

U.S. patent application Ser. No. 6,236,975 B1

U.S. patent application Ser. No. 6,285,983 B1

U.S. patent application Ser. No. 6,330,543 B1

U.S. patent application Ser. No. 6,330,554 B1

U.S. patent application Ser. No. 6,324,519 B1

U.S. patent application Ser. No. 6,327,574 B1

### BACKGROUND OF THE INVENTION

Many database marketing companies offer programs to Consumers whereby the Consumer's identity is purported to remain anonymous. Such database marketing techniques typically employ the following basic procedure:

1.The Database Marketer convinces the Consumer to provide (or otherwise obtains) information regarding their interests, brand preferences and buying habits. This data is collectively referred to as their “consumer profile.” The consumer profile also contains contact information, such as a mailing address or email address.

2.The Database Marketer enters into agreements with various Clients (advertisers) that wish to promote their products or services. These Clients have determined, through market research, that persons having specific buying patterns and characteristics (“buyer profiles”) are apt to be interested in participating in particular promotions.

3.The Database Marketer screens its database to target consumer profiles that match the buyer profile designated by their Client, and then emails the Client's promotion to targeted Consumers. Since neither the Consumers' identity nor contact data is disclosed to the Client, the Consumers remain anonymous to the Client.

4.Clients pay a fee to the Database Marketer based upon either the number of targeted emails sent, or upon the number of targeted Consumers that “click” the link to the client's website.

Although the Consumers' identity and contact information remain anonymous to Clients, they do not remain anonymous to the Database Marketer. Contact information is stored in the database, along with consumer profiles, and is used by Database Marketers to inform Consumers of promotions.

Even though encrypted server lines are commonly used, unauthorized dissemination of Customer information is a commonly perceived concern. Some companies sell database information or share it with related companies or strategic partners. Privacy and security concerns are major reasons why Consumers are reluctant to provide enough detailed information to allow advertisers to effectively target likely customers.

Due to this hesitancy by Consumers to provide detailed information, Database Marketers are often unable to compile sufficient data to construct meaningful consumer profiles, thereby making it difficult to effectively match prospects to particular promotions. As a result, targeted promotions are frequently of little interest to the recipient and are often regarded as a nuisance. This factor also contributes to the general reluctance of Consumers to participate in Database Marketers programs, such as opt-in email services.

With this invention, the Reverse Contact Marketing (“RCM”) System, Consumers' privacy issues are virtually eliminated because their identity and contact information are not collected. Instead, consumer profiles are associated with anonymous pass codes. In addition, it is impossible for the Consumer to receive unwanted email, or to be otherwise directly contacted through the RCM System, because contact information is not provided. Instead, Consumers have total control over when (and if) they choose to view targeted promotions or contact the advertisers. By removing privacy and nuisance concerns, Consumers will be more inclined to answer detailed surveys regarding preferences and buying habits. This will enable promoters to more accurately match promotions to viable customers, leading to higher response rates.

### DETAILED DESCRIPTION OF THE INVENTION

When first-time users visit the RCM website, they will be prompted to establish a username and password. These pass codes provide access to a dedicated Consumer file within the central server. A Consumer Profile Number is automatically assigned to each dedicated file. This number identifies the consumer profile for purposes of the promotion-matching process. The RCM System generally works as follows:

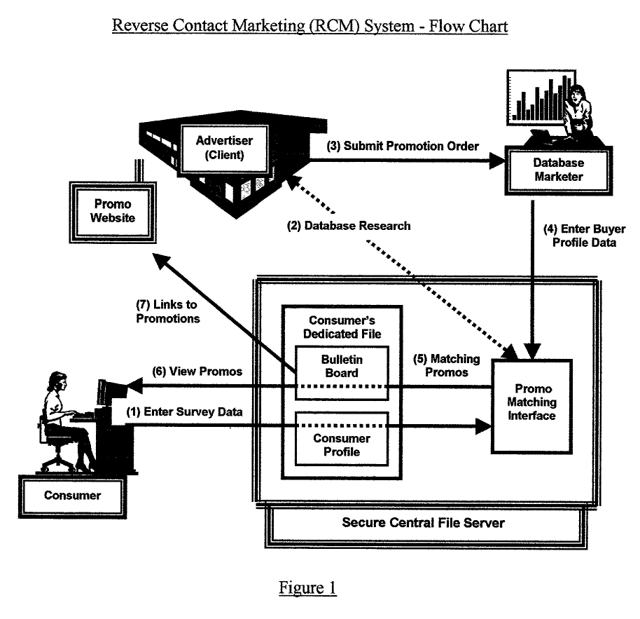

Steps correspond with the arrows in FIG. 1.

1.Upon entering their pass codes, registered Consumers gain access to their dedicated file, which is comprised of two main sections: a Consumer Profile Survey and a Promotions Bulletin Board. The Consumer may complete as much of the detailed survey as desired, and may revise their profile as interests change. Existing survey software will be licensed to perform this function, and such software application is not a part of this claim.

2.The Database Marketer enters into agreements with Clients that wish to promote products or services. Clients are granted access to the database for purposes of researching consumer profiles. The promotion-matching interface identifies consumer profiles that are consistent with the Client's designated criteria. Existing promotion-matching software will be licensed to perform this function, and such software application is not a part of this claim.

3.Once the Client researches the database and targets a set of relevant consumer profiles, a promotion distribution order is placed with the Database Marketer.

4.The Database Marketer enters the Client's order in the RCM System.

5.The promotion-matching interface identifies appropriate consumer profiles and posts the Client's website link (with a descriptive title) on bulletin boards of targeted Consumers.

6.After logging onto their dedicated bulletin boards, Consumers may view the titles of any promotions that have been deemed to match their profile.

7.When a Consumer clicks on any title of interest, they are anonymously routed to the Client's website to obtain further information.

Clients pay a fee based upon either the number of links posted to targeted bulletin boards, or the number of targeted consumers that are routed to the Client's website.

Optionally, software that enables access to the RCM System can be stored on a mini compact disk. These CDs would then be distributed to the public, providing exclusivity.

We claim:

1. An Internet-based method of obtaining personal data from consumers, and then providing these consumers with access to promotions that match their profiles, and doing so without collecting either their identity or contact information-whereby the consumers remain anonymous to all parties, including the database marketer, and cannot be contacted directly by any of the parties.

2. The method of claim 1, but additionally compromised by incorporating the entire Reverse Contact Marketing (RCM) System into a computer related network, such as the Internet, and web page that is part of any database marketer's or merchant's website.

3. The method of claim 1, but additionally compromised by incorporating the entire RCM System into a computer related network, such as the Internet, and web page other than any database marketer's or merchant's website.

4. The method of claim 1, but additionally compromised by incorporating the entire RCM System into the content of a marketing/display system, burned on a compact disk in any available format.
